(19) United States
(12) Patent Application Publication
(10) Pub. No.: US 2012/0150637 A1
(43) Pub. Date: Jun. 14, 2012

(54) Systems and Methods for Adding Commercial Content to Printouts

(76) Inventors: Samson J. Liu, Palo Alto, CA (US); Parag M. Joshi, Palo Alto, CA (US)

(21) Appl. No.: 13/391,637

(22) PCT Filed: Aug. 26, 2009
(86) PCT No.: PCT/US09/55043

§ 371 Date: Feb. 22, 2012

(51) Int. Cl. G06Q 30/02

(52) U.S. Cl. 705/14.49

(57) ABSTRACT

In one embodiment, a system and method relate to detecting a print command received by a network browser of a client computer, the print command reflecting an interest to print content of a network page displayed in the network browser as a hard copy printout, analyzing the network page content to determine its underlying subject matter, identifying commercial content relevant to the underlying subject matter, and creating and formatting a document that includes the network page content and the identified commercial content.

### BACKGROUND

Although targeted advertising is common on the World Wide Web, such advertising may have little lasting impact on the web user given that the advertising is often quickly replaced with other web content as the user surfs from web page to web page. Of potentially greater value would be commercial content that is of a more permanent nature, and therefore more likely to be noticed and acted upon by the web user.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which commercial content can be added to web printouts.

FIG. 2 is a block diagram of an embodiment of a client computer shown in FIG. 1.

FIG. 3 is a block diagram of an embodiment of a server computer shown in FIG. 1.

FIG. 4 is a flow diagram that illustrates an embodiment of a method for adding commercial content to a web printout.

FIG. 5 is a flow diagram that illustrates an embodiment of a client-based method for adding commercial content to a web printout.

FIGS. 6A and 6B together comprise a flow diagram that illustrates an embodiment of a server-based method for adding commercial content to a web printout.

FIG. 7A is a schematic view of an example of a conventional web printout.

FIG. 7B is a schematic view of an example of a web printout that can result when the disclosed systems and methods are used to reformat the printout and add commercial content to the printout.

### DETAILED DESCRIPTION

As described above, existing online targeted advertising may have little lasting impact on the typical web user. Therefore, it can be appreciated that it would be desirable to have a system or method for providing more permanent commercial content to the web user. Disclosed herein are systems and methods that achieve that goal by adding commercial content to web printouts, i.e., documents that result when a web page accessed and viewed with a network browser is printed by a user.

In some embodiments, the content that the user has sought and presumably wishes to preserve by printing (i.e., the desired web content) is identified and analyzed to determine its underlying subject matter or semantic information. Next, commercial content, such as advertisements and/or coupons, pertinent to the underlying subject matter is identified. Once the commercial content has been identified, a document is created and formatted for printing that comprises both the desired web content and the commercial content, which may be formatted for unobtrusive placement on the printed page. In some embodiments, the document excludes much of the extraneous web content that most users do not wish to preserve in a printout, such as web site navigation features, hyperlinks to other web pages, and online advertisements. By filtering such content, a printout having improved formatting and less clutter results, even though commercial content has been added.

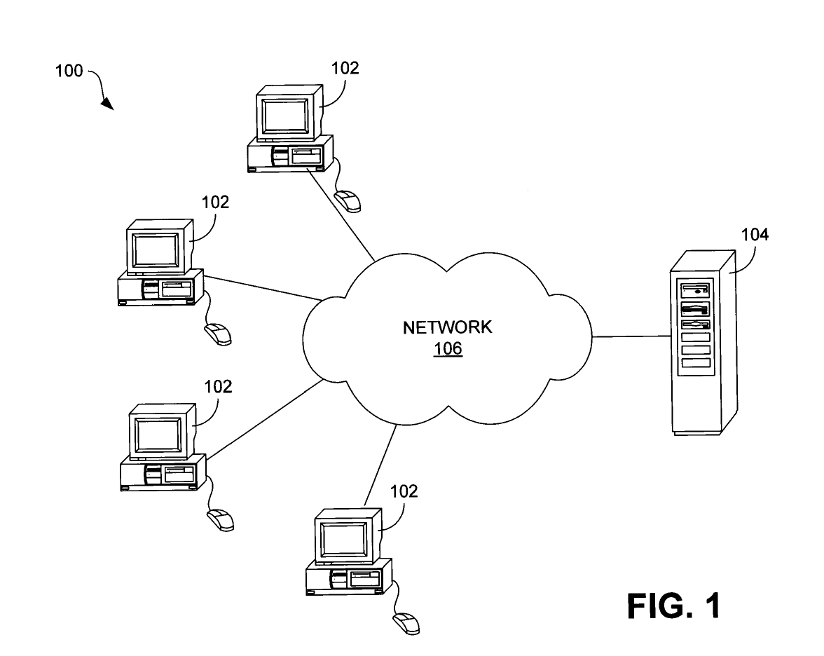

Referring now in more detail to the drawings, in which like numerals indicate corresponding parts throughout the several views, FIG. 1 illustrates an example system 100. As indicated in that figure, the system 100 generally comprises client computers 102 and a central server computer 104. In the embodiment of FIG. 1, the client computers 102 comprise personal computers (PCs) that are configured to communicate with the server computer 104 via a network 106, which in some embodiments comprises the Internet. Although PCs are illustrated in FIG. 1 by way of example, it is to be appreciated that substantially any network-enabled device could be used, including notebook computers, handheld computers, mobile telephones, media players, gaming consoles, and the like. In addition to communicating with the server computer 104, the client computers 102 can also access web content, for example in the form of web sites and web pages, via the network 106 using an appropriate program, such as a network browser.

As described in greater detail below, the server computer 104 is, in some embodiments, configured to identify desired web content that is to be printed and further to identify commercial content that is to be added to the printout. The sever computer 104 is further configured to create and format the document that will be used to generate a printout. In some embodiments, the server computer 104 is further configured to filter out at least some of the web content of the content source (e.g., web page) to improve printout format and reduce printout clutter.

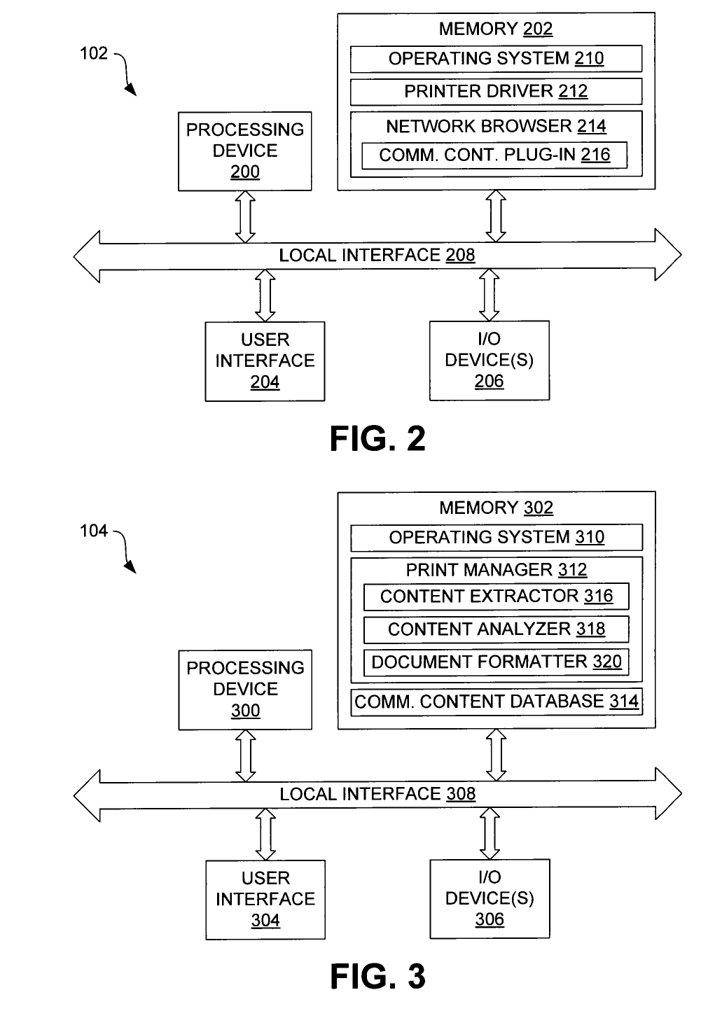

FIG. 2 is a block diagram illustrating an example architecture for one of the client computers 102. The computer 102 of FIG. 2 comprises a processing device 200, memory 202, a user interface 204, and at least one I/O device 206, each of which is connected to a local interface 208.

The processing device 200 can include a central processing unit (CPU) or an auxiliary processor among several processors associated with the computer 102, or a semiconductor based microprocessor (in the form of a microchip). The memory 202 includes any one of or a combination of volatile memory elements (e.g., RAM) and nonvolatile memory elements (e.g., hard disk, ROM, tape, etc.).

The user interface 204 comprises the components with which a user interacts with the computer 102. The user interface 204 may comprise, for example, a keyboard, mouse, and a display, such as a cathode ray tube (CRT) or liquid crystal display (LCD) monitor. The one or more I/O devices 206 are adapted to facilitate communications with other devices and may include one or more communication components such as a modulator/demodulator (e.g., modem), wireless (e.g., radio frequency (RF)) transceiver, network card, etc.

The memory 202 comprises various programs including an operating system 210, a printer driver 212, and a network browser 214. The operating system 210 controls the execution of other programs and provides scheduling, input-output control, file and data management, memory management, and communication control and related services. The printer driver 212 is configured to translate content from user applications, such as the network browser 214, into print content that can be transmitted to an appropriate printing device for the generation of a hard copy printout. The network browser 214 is a program that is configured to access and display network content. In embodiments in which the network browser 214 is used to browse the World Wide Web (“the web”) over the Internet, the network browser 214 can be a web browser that accesses and displays content comprised by web pages.

In the embodiment of FIG. 2, the network browser 214 includes a commercial content plug-in 216 that is configured to automatically add commercial content to printouts of web content. As described in greater detail below, the plug-in 216 can be configured to analyze the web content to determine its underlying subject matter or semantic information to enable selection of appropriate commercial content to add, or to at least identify the web content to another device (e.g., a central server computer) that can perform such analysis.

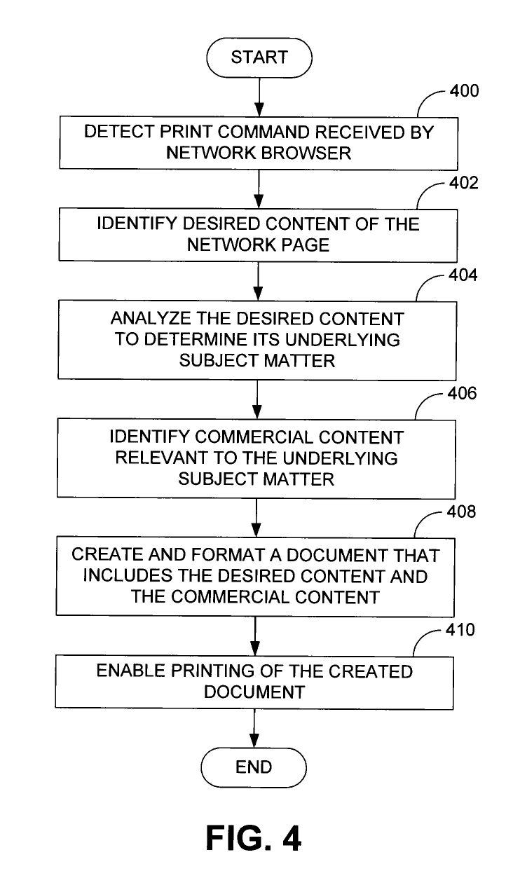

FIG. 3 is a block diagram illustrating an example architecture for the server computer 104 shown in FIG. 1. As indicated in FIG. 3, the server computer 104 comprises many of the same components as the client computer 102 shown in FIG. 2, including a processing device 300, memory 302, a user interface 304, and at least one I/O, device 306, each of which is connected to a′ local interface 308. In some embodiments, those components have the same or similar construction and/or function of like-named components described above in relation to FIG. 2. Accordingly, a detailed discussion of the components of FIG. 3 is not presented herein.

As indicated in FIG. 3, the memory 302 of the server computer 104 comprises an operating system 310, a print manager 312, and a commercial content database 314. The operating system 310 controls the execution of other programs and provides scheduling, input-output control, file and data management, memory management, and communication control and related services.

The print manager 312 is configured to control printing of web content. Such control includes control over the format of the web content as well as control over what commercial content is to be added to a printout of the web content. In the illustrated embodiment, the print manager 312 comprises various modules, including a content extractor 316 that extracts desired web content from web pages, a content analyzer 318 that determines the underlying subject matter or semantic information of the desired web content and identifies pertinent commercial content, and a document generator 320 that creates and formats a: document for printing that comprise both the desired web content and the commercial content. In some embodiments, the content extraction inherently filters undesired web content (e.g., web site navigation features, hyperlinks to other web pages, and online advertisements) from the document. The commercial content added to the document can be obtained from the commercial content database 314, which stores and categorizes various commercial content (e.g., advertisements and/or coupons) available for addition to documents to be printed.

Example systems having been described above, operation of the systems will now be discussed. In the discussions that follow, flow diagrams are provided. Process steps or blocks in the flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

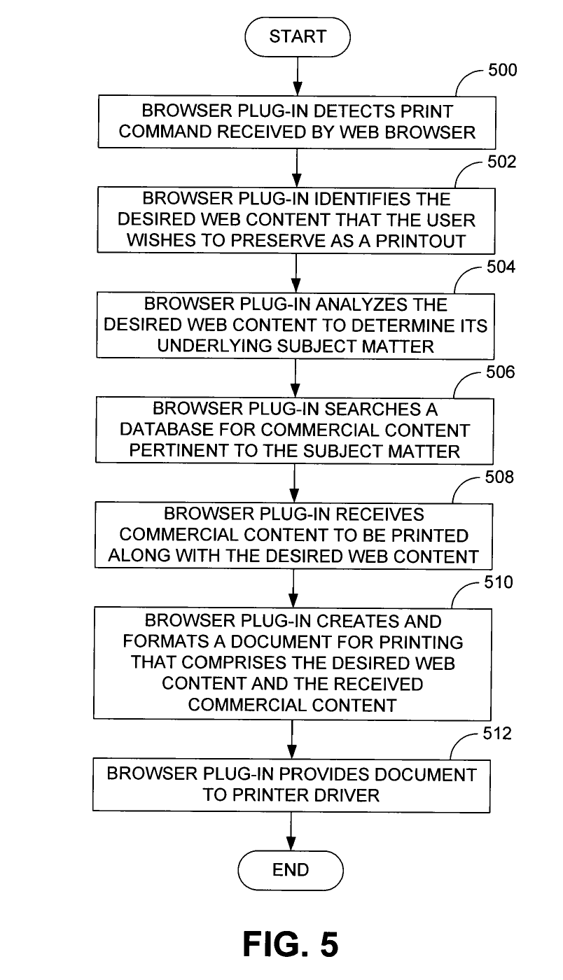

FIG. 4 illustrates an example method for adding commercial content to a web printout. In some embodiments, the method described in relation to FIG. 4 can be performed on the client device 102, on the server computer 104, or a combination of both. Beginning with block 400, a print command received by the network browser is detected. Receipt of such a command conveys a desire on the part of the network browser user to print content (e.g., web content) of a network page (e.g., web page) displayed a window of the network browser. As described above, the network page will often comprise content that the user wishes to preserve in the hard copy printout (i.e., desired content) as well as other content that forms part of the network page but that the user does not wish to preserve (i.e., undesired content). The desired content may comprise, for example, one or more of a written article, a graphic, or an image that is the central subject or focus of the network page. The undesired content may comprise one or more extraneous features of the network page, such as web site navigation features, hyperlinks to other web pages, and online advertisements.

Next, the desired content is identified (block 40) and analyzed to determine its underlying subject matter or semantic information (block 404). Such analysis can be performed on the hypertext markup language (HTML) that is the basis of the network page. By way of example, if the desired content comprises a written article, the analysis can comprise analysis of the words, phrases, or sentences used in the article to determine one or more themes of the article. If, on the other hand, the desired content is a graphic or image, analysis can comprise analysis of tags associated with the graphic or image that describe it or direct analysis of the image data (e.g., pixels) of the graphic of image to determine the subject of the graphic or image.

Irrespective of the manner of analysis, that is performed, commercial content is then identified that is relevant to the determined underlying subject matter or semantic information, as indicated in block 406. In some embodiments, such an identification comprises a comparison of the determined underlying subject matter or semantic information with categories or keywords under which commercial content is stored.

Next, with reference to block 408, a document is created and formatted for printing that includes both the desired content and the identified commercial content. Such creation enables printing of the created document, as indicated in block 410.

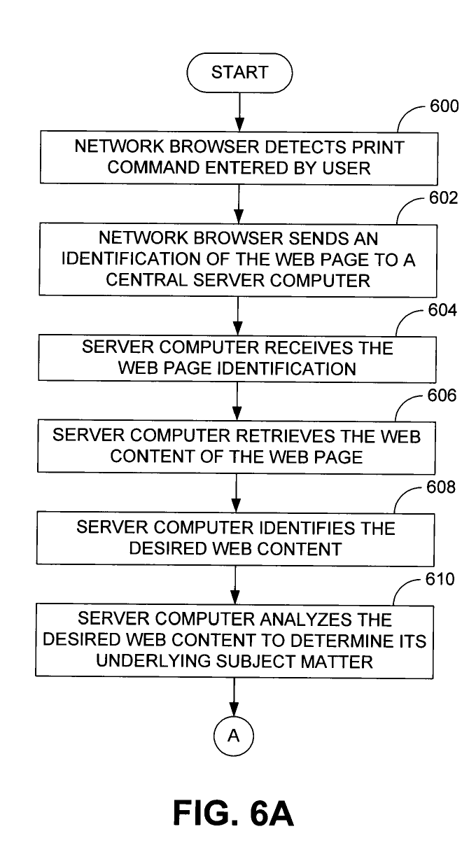

FIG. 5 illustrates an example method for creating a web printout that includes commercial content. More particularly, FIG. 5 illustrates a client-based method for adding the commercial content in which software, in the form of a browser plug-in (e.g., plug-in 216 of FIG. 2) on the client device, performs analysis on desired content. In the embodiment of FIG. 5 it is assumed that the user is browsing the web using a web browser.

Beginning with block 500 of FIG. 5, the browser plug-in detects a print command received by the web browser. The print command can have been entered by the browser user by selecting a “print” button or “print” command comprised by the browser window. Detection of the command is facilitated by the fact that the plug-in forms part of the web browser and therefore has intimate knowledge of commands received by the web browser. Once the print command is detected, the browser plug-in identifies the desired web content that the user wishes to preserve as a hard copy printout, as indicated in block 502. In some embodiments, such identification comprises identifying the main content of the web page the user viewed when the print command was received. Such content may comprise the bulk of the web page and/or may be centrally located within the web page. In some embodiments, the main content can be identified by one or more tags that highlight the main content as such.

Once the desired web content is identified, the browser plug-in analyzes that content to determine its underlying subject matter or semantic information, as indicated in block 504. As described above, the analysis can comprise analyzing the words, phrases, or sentences used in the desired web content and/or analyzing tags associated with the content.

At this point, the browser plug-in searches a database of commercial content to identify commercial content, for example advertisements and/or coupons, that is pertinent to the determined underlying subject matter, as indicated in block 506. In some embodiments, such searching comprises the browser plug-in sending a search query to a central server computer (e.g., server computer 104 of FIG. 3) that controls the database. Such a search query can comprise semantic information, such as a keyword, that describes the underlying subject matter of the desired web content and therefore identify the type of commercial content that would be relevant. In such embodiments, the central server computer can reply with commercial content, for instance in the form of one or more advertisements and/or coupons, that are relevant to the desired web content. The server computer can, for example, identify such content by cross-referencing the semantic information with category headings or tags of a commercial content database. For example, if it is determined that the desired web content relates to a particular travel destination, relevant commercial content may comprise advertisements for hotels at that destination and/or coupons for rental cars available at that location. To cite another example, if it is determined that the desired web content is a description of a particular printer offered for sale, relevant commercial content may comprise coupons for toner cartridges that are used by the printer.

Next, with reference to block 508, the browser plug-in receives commercial content to be printed along with the desired web content. The browser plug-in can then create and format a document comprising both the desired web content and the received commercial content, as indicated in block 510. Then, with reference to block 512, the browser plug-in provides the document to the printer driver for translation and transmission to the printing device that will generate the hard copy printout.

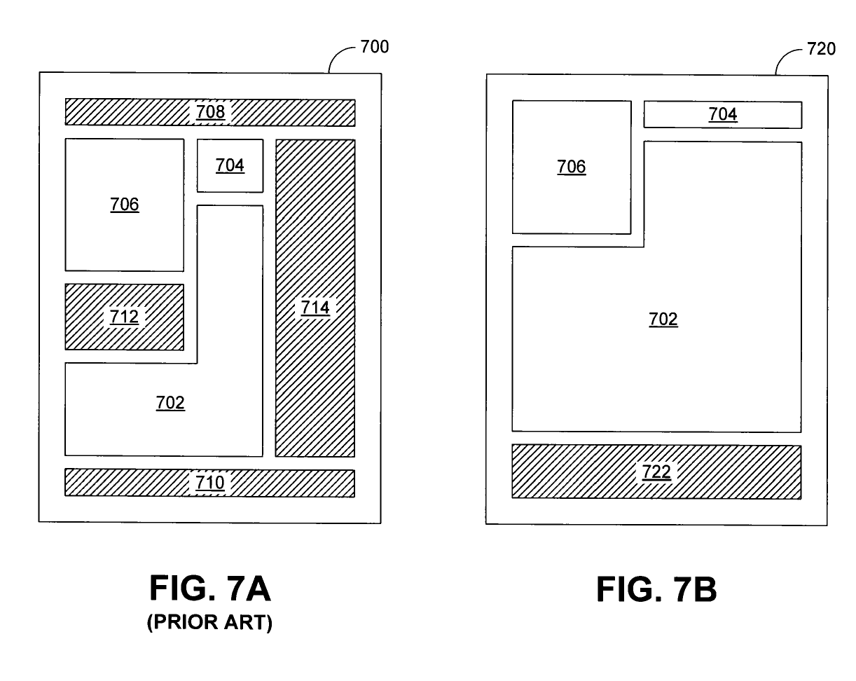

In some embodiments, the printout will only or nearly only comprise the desired web content and the received commercial content and therefore will exclude much or all of the undesired extraneous web content. With the exclusion or filtering of that extraneous web content, a cleaner, better formatted printout will result. FIGS. 7A and 7B illustrate this point. FIG. 7A is a schematic view of a page 700 of an example printout that would result when a web site is printed in the conventional manner. As shown in that figure, the page 700 comprises a written article 702 and an associated title 704 and photograph 706. Presumably, a user would like to preserve each of those elements when printing. Also appearing in the page 700, however, is various extraneous web content, including navigation bats 708 and 710 and online advertisements 712 and 714. As can be appreciated from FIG. 7A, the desired web content (i.e., elements 702, 704, 706) only accounts for about half of the available space of the page 700. Moreover, because so much of the available space is occupied by extraneous web content, the article 702 may not fit on the single page 700 and may therefore run on to multiple other pages that may also comprise various extraneous web content.

FIG. 7B is a is a schematic view of a page 720 of an example printout that could result when the web site that provided content for the page 700 is printed using the systems and methods described herein. As with the page 700, the page 720 comprises the written article 702 and its associated title 704 and photograph 706. Unlike the page 700, however, the page 720 excludes the extraneous web content, including the navigation bars 708 and 710 and the online advertisements 712 and 714. As is further illustrated in FIG. 7B, the page 720 includes the received commercial content 722, which in the example of FIG. 7B is positioned adjacent the bottom edge of the page below the article 702. As can be appreciated from comparison of FIGS. 7A and 7B, the printout that results using the disclosed systems and methods is formatted much, more desirably even with the inclusion of the commercial content 722. Although the commercial content 722 has been shown provided along the bottom edge of the page in FIG. 7B, it is to be appreciated that the commercial content could be placed in any other location on the page, including on the reverse side of the page where double-sided printing is available. In some embodiments, relatively unobtrusive positioning of the commercial content is preferred so as to not unduly detract from the desired web content.

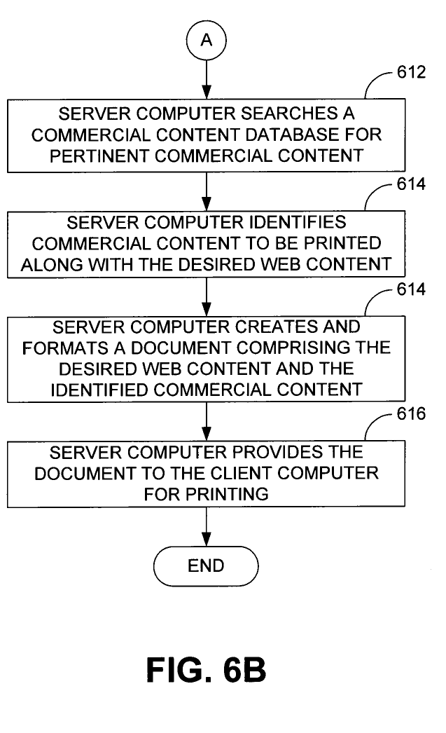

FIGS. 6A and 6B illustrates a further example method for creating a web printout that includes commercial content. In the embodiment of FIGS. 6A and 6 B, however, a server-based method is used in which a server computer receives an identification of a web page that into be printed and creates a document for printing that includes the desired content of the web page. Beginning with block 600 of FIG. 6A, a network browser executing on a client computer detects a print command entered by a user. In some embodiments, the detection is made by a browser plug-in that forms part of the browser. The network browser (e.g., browser plug-in of the browser) then sends an identification of the web page that was displayed when the print command was received to a central server computer, as indicated in block 602. In some embodiments, the identification comprises a uniform resource locator (URL) of the web page.

Referring next to block 604, the server computer receives the web page identification and, as indicated in block 606, retrieves the web content of the web page. Next, the server computer identifies the desired web content that the user wishes to preserve as a hard copy printout, as indicated in block 608. As before, such identification comprises identifying the main content of the web page. Once the desired web content is identified, the server computer analyzes that content to determine its underlying subject matter or semantic information, as indicated in block 610 and searches a commercial content database for commercial content, for example advertisements and/or coupons, that is pertinent to the determined underlying subject matter, as indicated in block 612 of FIG. 6B.

Next, with reference to block 614, the server computer identifies commercial content to be printed along with the desired web content, and then creates and formats a document comprising both the desired web content and the identified commercial content, as indicated in block 616. At that point, the server computer provides the document to the client computer for printing on an appropriate printing device in communication with the client computer, as indicated in block 618.

In the methods described above, revenue can be generated by the placement of the commercial content on the web printouts. In some embodiments, the central server computer or other device that controls access to the commercial content database can track which pieces of commercial content are used and how often and can therefore can determine what to charge the advertiser in a per-print scenario.

It is noted that, in some embodiments, the user can opt-in or opt-out with respect to commercial content being added to his or her web printouts. Incentives may be provided, however, to encourage opting in. For example, in a pay-for-printing scenario, printing fees may be discounted or waived in cases in which the user agrees to the inclusion of commercial content on his or her web printouts.

We claim:

1. A method for adding commercial content to a web printout, the method comprising:
detecting a print command received by a network browser of a client computer, the print command reflecting an interest to print content of a network page displayed in the network browser as a hard copy printout;
analyzing the network page content to determine its underlying subject matter;
identifying commercial content relevant to the underlying subject matter; and
creating and formatting a document that includes the network page content and the identified commercial content.

2. The method of claim 1, wherein detecting a print command comprises a browser plug-in associated with the network browser detecting the print command.

3. The method of claim 2, wherein analyzing the network page content comprises the browser plug-in analyzing the network page content.

4. The method of claim 2, wherein analyzing the network page content comprises a server computer remote to the client computer analyzing the network page content.

5. The method of claim 1, wherein analyzing the network page content comprises analyzing words, phrases, or sentences used in an article of the network page to determine a theme of the article.

6. The method of claim 1, wherein analyzing the network page content comprises analyzing a graphic or image of the network page.

7. The method of claim 1, wherein identifying commercial content comprises searching a database of commercial content for commercial content that is relevant to the network page content.

8. The method of claim 1, wherein creating and formatting a document comprises creating a document that excludes extraneous content of the network page.

9. The method of claim 1, wherein creating and formatting a document comprises positioning the identified commercial content adjacent a bottom edge of the document.

10. The method of claim 1, further comprising printing a hard copy printout of the document.

11. A computer-readable medium that stores a browser plug-in configured for use with a network browser comprising:
logic configured to detect a print command received by the network browser;
logic configured to analyze the network page content to determine its underlying subject matter;
logic configured to identify commercial content relevant to the underlying subject matter; and
logic configured to create and format a document that includes the network page content and the identified commercial content.

12. The computer-readable medium of claim 11, wherein the logic configured to analyze the network page content is configured to analyze words, phrases, or sentences used in an article of the network page.

13. The computer-readable medium of claim 11, wherein the logic configured to analyze the network page content is configured to analyze a graphic or image of the network page.

14. The computer-readable medium of claim 11, wherein the logic configured to identify commercial content is configured to send a database query to a remote commercial content database, the query comprising semantic information that identifies the nature of the underlying subject matter of the network page content.

15. A computer-readable medium that stores a print manager comprising:
logic configured to receive from a client computer via a network an identification of a network page that is to be printed;
logic configured to retrieve content of the network page using the identification;
logic configured to analyze the network page content to determine its underlying subject matter;
logic configured to identify commercial content relevant to the underlying subject matter;
logic configured to create and format a document that includes the network page content and the identified commercial content; and
logic configured to send the document back to the client computer for printing via the network.

16. The computer-readable medium of claim 15, wherein the logic configured to retrieve content of the network page is configured to retrieve the network page content using a universal resource locator (URL) of the network page.

17. The computer-readable medium of claim 15, wherein the logic configured to analyze the network page content is configured to analyze words, phrases, or sentences used in an article of the network page.

18. The computer-readable medium of claim 15, wherein the logic configured to analyze the network page content is configured to analyze a graphic or image of the network page.

19. The computer-readable medium of claim 15, wherein the logic configured to identify commercial content is configured to search a commercial content database for commercial content that matches the underlying subject matter.
